(19) United States
(12) Patent Application Publication
(10) Pub. No.: US 2022/0374233 A1
(43) Pub. Date: Nov. 24, 2022

(54) DATA ACCESS PERFORMANCE IN A MEMORY

(71) Applicant: International Business Machines Corporation, Armonk, NY (US)

(72) Inventors: Ming Ran Liu, Beijing (CN); Xiao Yan Tang, Beijing (CN); Bao Zhang, Beijing (CN); Jing Lu, Beijing (CN); Dong Hui Liu, Beijing (CN); Peng Hui Jiang, Beijing (CN); Yong Yin, Beijing (CN); Jia Yu, Beijing (CN)

(21) Appl. No.: 17/327,903

(22) Filed: May 24, 2021

(51) Int. Cl. G06F 9/30; G06F 9/50; G06F 9/54; G06F 12/02

(52) U.S. Cl. CPC G06F 9/3004; G06F 9/5016; G06F 9/542; G06F 12/0238

(57) ABSTRACT

In an approach for improving data access performance in memory, a processor monitors each data access to a data element in the memory from an application, wherein the application has a plurality of functions. A processor records, during runtime, each data access into a monitoring element table, wherein the record for each data access includes an identity, a start address, an end address, and a memory page number. A processor clusters recorded data accesses for each function based on a distance between data elements accessed in sequence. A processor allocates, based on the data element clustering result, the data elements in a same cluster into a same memory unit in the memory.

### BACKGROUND

The present disclosure relates generally to the field of data access and analysis, and more particularly to improving data access performance in a memory during runtime.

Data access may refer to software and activities related to storing, retrieving, or acting on data housed in a database or other repository. Data access may involve authorization to access different data repositories. An in-memory database may be a database management system that primarily relies on main memory for computer data storage. Main memory databases may store data on volatile memory devices. Memory management may be a form of resource management applied to computer memory. The essential requirement of memory management may be to provide ways to dynamically allocate portions of memory to programs at request, and free the memory for reuse when no longer needed. Several methods have been devised that increase the effectiveness of memory management. Virtual memory systems may separate the memory addresses used by a process from actual physical addresses, allowing separation of processes and increasing the size of the virtual address space beyond the available amount of random-access memory using paging or swapping to secondary storage. The quality of the virtual memory manager can have an extensive effect on overall system performance.

### SUMMARY

Aspects of an embodiment of the present disclosure disclose an approach for improving data access performance in memory. A processor monitors each data access to a data element in the memory from an application, wherein the application has a plurality of functions. A processor records, during runtime, each data access into a monitoring element table, wherein the record for each data access includes an identity, a start address, an end address, and a memory page number. A processor clusters recorded data accesses for each function based on a distance between data elements accessed in sequence. A processor allocates, based on the data element clustering result, the data elements in a same cluster into a same memory unit in the memory.

### BRIEF DESCRIPTION OF THE DRAWINGS

FIG. 1 is a functional block diagram illustrating a data access performance improvement environment, in accordance with an embodiment of the present disclosure.

FIG. 2 is a flowchart depicting operational steps of a performance improvement module within a computing device of FIG. 1, in accordance with an embodiment of the present disclosure.

FIG. 3 illustrates an exemplary functional diagram of the performance improvement module in the computing device of FIG. 1, in accordance with an embodiment of the present disclosure.

FIG. 4A illustrates an exemplary monitoring function table of the performance improvement module in the computing device of FIG. 1, in accordance with an embodiment of the present disclosure.

FIG. 4B illustrates an exemplary monitoring element table of the performance improvement module in the computing device of FIG. 1, in accordance with an embodiment of the present disclosure.

FIG. 5 is a block diagram of components of the computing device of FIG. 1, in accordance with an embodiment of the present disclosure.

### DETAILED DESCRIPTION

The present disclosure is directed to systems and methods for improving data access performance in memory.

Embodiments of the present disclosure recognize a need for improving data access performance as the request of frequent and massive data accessing is rapidly increasing, for example, in machine learning, artificial intelligent, and data analysis. The frequent and massive data accessing may impact application program performance dramatically, because the data accessed in succession may reside on different memory pages which would cause pre-read or cache line missed. Embodiments of the present disclosure disclose providing a runtime library-based method to improve data access performance by utilizing a data accessing sequence clustering result. Embodiments of the present disclosure disclose recording data element accessing information triggered by a new signal received when the corresponding data area is accessed. Embodiments of the present disclosure disclose generating a report for each function including a distance between data areas accessed in succession and the data areas clustering result. Embodiments of the present disclosure disclose, based on the report, allocating the data areas in one cluster in a same memory management unit to improve the data access performance. Embodiments of the present disclosure disclose a method that improves the data access performance without changing program source code or recompiling program.

Embodiments of the present disclosure disclose a monitoring element table generated during runtime to record data element accessing information. Embodiments of the present disclosure disclose a method to generate a report of each function for a data area distance and clustering result. Embodiments of the present disclosure disclose a method to allocate data areas in a memory unit based on the generated report. Embodiments of the present disclosure disclose a runtime option to specify whether to enable a runtime library learning mode and which function to be optimized.

Embodiments of the present disclosure disclose a memory allocation routine to allocate a heap memory and to identify a specific memory per a request. The memory allocation routine may locate a return address to a caller and may calculate an offset. The offset may be used as an independent identity for a heap element. The identity may include a function name and the independent identity for the heap element. Embodiments of the present disclosure disclose a learning mode. For example, when a program runs in the learning mode, a runtime library may record each access to the memory allocated, may learn a most possible memory access order, and may provide a suggestion report for a heap allocation. Embodiments of the present disclosure disclose an optimization mode. For example, in the optimization mode, a memory allocation function may allocate a memory element, which is more likely to access in an order, into a same memory page.

Embodiments of the present disclosure disclose generating a memory allocation strategy. Embodiments of the present disclosure disclose determining which elements should be allocated on a same memory page. Embodiments of the present disclosure disclose formulating a coarse-grained memory allocation strategy based on memory accessing features to improve caching hit rate. Embodiments of the present disclosure disclose using a clustering algorithm to analyze memory accessing data and aggregate memory elements into one cluster. Memory elements in one cluster may be allocated on a same memory page. Embodiments of the present disclosure disclose using a heuristic algorithm to optimize the coarse-grained memory allocation strategy. Embodiments of the present disclosure disclose a fine-grained memory allocation strategy based on a real operating efficiency.

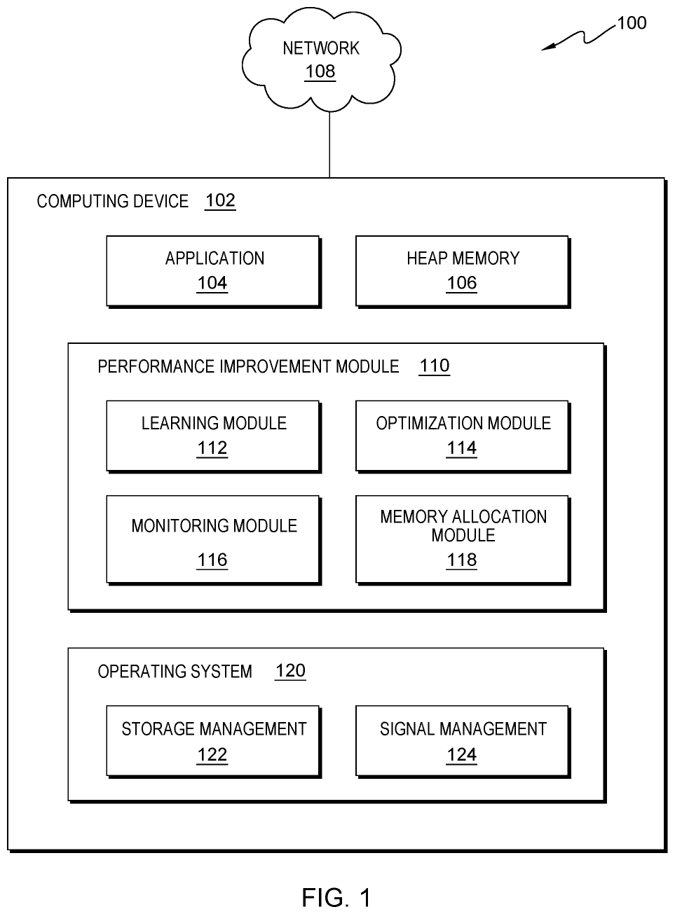

The present disclosure will now be described in detail with reference to the Figures. FIG. 1 is a functional block diagram illustrating data access performance improvement environment, generally designated 100, in accordance with an embodiment of the present disclosure.

In the depicted embodiment, data access performance improvement environment 100 includes computing device 102 and network 108.

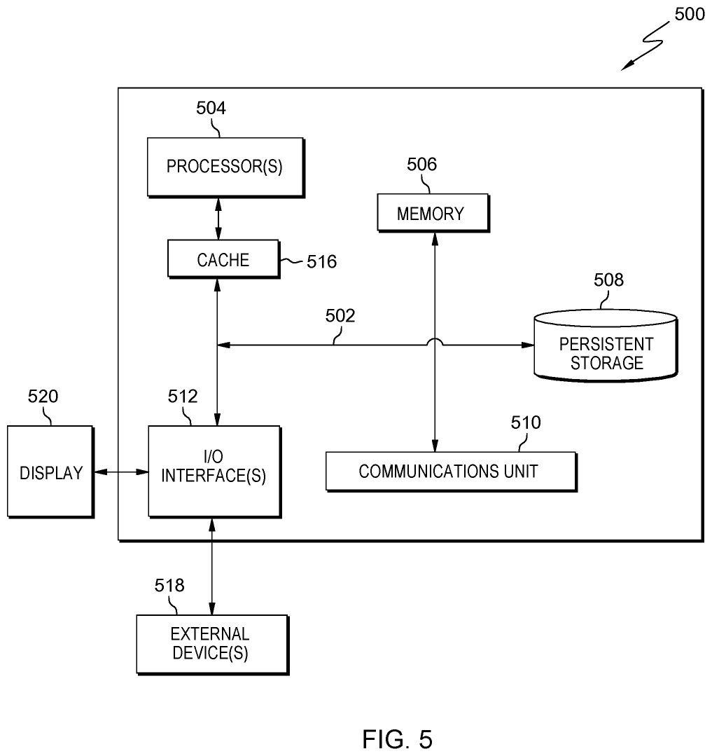

In various embodiments of the present disclosure, computing device 102 can be a laptop computer, a tablet computer, a netbook computer, a personal computer (PC), a desktop computer, a mobile phone, a smartphone, a smart watch, a wearable computing device, a personal digital assistant (PDA), or a server. In another embodiment, computing device 102 represents a computing system utilizing clustered computers and components to act as a single pool of seamless resources. In other embodiments, computing device 102 may represent a server computing system utilizing multiple computers as a server system, such as in a cloud computing environment. In general, computing device 102 can be any computing device or a combination of devices with access to performance improvement module 110 and network 108 and is capable of processing program instructions and executing performance improvement module 110, in accordance with an embodiment of the present disclosure. Computing device 102 may include internal and external hardware components, as depicted and described in further detail with respect to FIG. 5.

Further, in the depicted embodiment, computing device 102 includes application 104, heap memory 106, performance improvement module 110, and operating system 120. In the depicted embodiment, performance improvement module 110 is located on computing device 102. However, in other embodiments, performance improvement module 110 may be located externally and accessed through a communication network such as network 108. The communication network can be, for example, a local area network (LAN), a wide area network (WAN) such as the Internet, or a combination of the two, and may include wired, wireless, fiber optic or any other connection known in the art. In general, the communication network can be any combination of connections and protocols that will support communications between computing device 102 and performance improvement module 110, in accordance with a desired embodiment of the disclosure.

In one or more embodiments, application 104 may be a computing software designed to carry out a specific task other than one relating to the operation of the computer itself. In an example, application 104 may include multiple applications bundled together. Application 104 may have related functions, features, and user interfaces. Application 104 may use heap memory 106 to store global variables. Application 104 may access data stored in heap memory 106. In one or more embodiments, heap memory 106 may be a memory used by programming languages to store global variables. By default, all global variables may be stored in heap memory space. Heap memory 106 may support dynamic memory allocation.

In one or more embodiments, operating system 120 may be system software that manages computer hardware, software resources, and provides common services for computer programs (e.g., application 104). In the depicted embodiment, operating system 120 includes storage management 122 and signal management 124. Storage management 122 may refer to the management of the data storage used to store the user/computer generated data. Signal management 124 is configured to manage a signal generated from operating system 120. For example, a signal may be used to notify a process of a synchronous or asynchronous event. When a signal is sent, operating system 120 may interrupt the target process' normal flow of execution to deliver the signal. If the process has previously registered a signal handler, that routine is executed. Signals may be a limited form of inter-process communication. A signal may be an asynchronous notification sent to a process or to a specific thread within the same process to notify the process of an event.

In one or more embodiments, performance improvement module 110 is configured to monitor each data access to a data element in heap memory 106 from application 104 which may include a plurality of functions. Performance improvement module 110 may receive a notification, e.g., from operating system 120, that a memory unit (e.g., a data area) in heap memory 106 is accessed. Performance improvement module 110 may receive a signal from signal management 124 when the corresponding data area is accessed. The signal may be used to notify a process of the event that the corresponding data area is accessed. When a signal is sent, operating system 120 may interrupt the target process' normal flow of execution to deliver the signal. Performance improvement module 110 may identify the memory unit when the memory unit is accessed. Performance improvement module 110 may locate a return address to the caller and may calculate the offset. Performance improvement module 110 may use the offset as an independent identity for the heap element (e.g., the memory unit). The identity for the memory unit may include a function name and the offset. For example, if the function name is Func_A ( ), the identity of one heap element (e.g., memory unit) can be Func_A_0000AA.

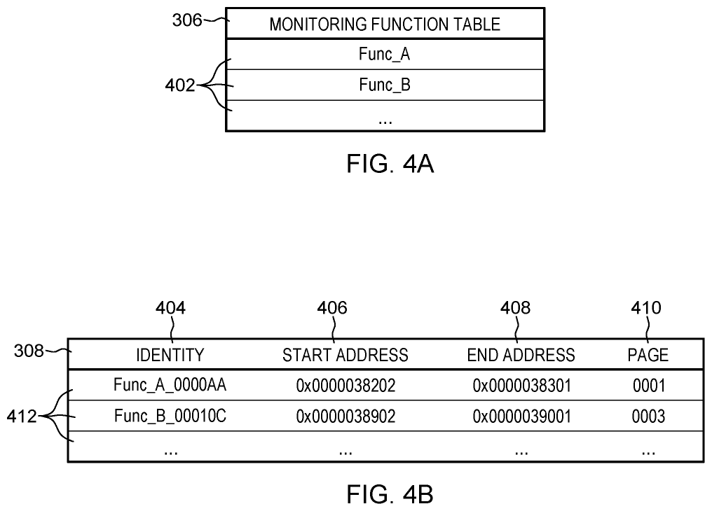

In one or more embodiments, performance improvement module 110 is configured to record, during runtime, each data access into a monitoring element table. The record for each data access may include an identity, a start address, an end address, and a memory page number. Performance improvement module 110 may monitor data element accessing information associated with the data area triggered by the notification from signal management 124. Performance improvement module 110 may generate a monitoring function table that includes functions from application 104. Performance improvement module 110 may generate a monitoring element table during runtime to record the data element accessing information. FIGS. 4A-4B illustrates examples of a monitoring function table and a monitoring element table. Performance improvement module 110 may check whether an accessed address in heap memory 106 for application 104 is in the range of an element in the monitoring element table. Performance improvement module 110 may save a record if the accessed address is in the monitoring element table.

In one or more embodiments, performance improvement module 110 is configured to cluster recorded data accesses for each function based on a distance between data elements accessed in sequence in heap memory 104. Performance improvement module 110 may generate a report for each function including a distance between data areas accessed in succession and a data area clustering result. Performance improvement module 110 may generate the report of each function for the data area distance and the clustering result. In an example, the distance between data areas, e.g., heap element A and heap element B, can reflect the relationship of the heap elements. Performance improvement module 110 may define the distance of the heap elements. Performance improvement module 110 may calculate average heap elements distance. Performance improvement module 110 may discard a disturbance distance by using a pre-defined threshold to control which distance should be involved during the calculation. Performance improvement module 110 may calculate only the heap element pairs which has enough significative distances. Performance improvement module 110 may cluster heap elements. Each cluster may contain heap elements which total size is no more than one page of memory in heap memory 106.

In one or more embodiments, performance improvement module 110 is configured to allocate, based on the data element clustering result, the data elements in a same cluster into a same memory unit in heap memory 106. Performance improvement module 110 may allocate the data areas in one cluster in a same memory management unit to improve the data access performance. Performance improvement module 110 may allocate data areas in a memory unit based on the generated report. Performance improvement module 110 may determine which heap elements should be allocated on the same memory page in heap memory 106. Performance improvement module 110 may generate a coarse-grained memory allocation strategy. For example, performance improvement module 110 may formulate the coarse-grained memory allocation strategy based on memory accessing features to improve a caching hit rate. Performance improvement module 110 may use a clustering algorithm to analyze memory accessing data and aggregation memory elements whose accessing times may be close in one cluster. Performance improvement module 110 may allocate heap memory elements in one cluster on a same memory page in heap memory 106. Performance improvement module 110 may generate a fine-grained memory allocation strategy. Performance improvement module 110 may make the coarse-grained memory allocation strategy as the initial status of the fine-grained memory allocation strategy. For example, performance improvement module 110 may use a heuristic algorithm to optimize the coarse-grained memory allocation strategy. Performance improvement module 110 may choose a system operation time as the optimization goal to ensure total efficiency based on the strategy.

In the depicted embodiment, performance improvement module 110 includes learning module 112, optimization module 114, monitoring module 116, and memory allocation module 118. In one or more embodiments, learning module 112 is configured to specify whether to enable a learning mode. When a program runs in a learning mode, learning module 112 may record each access to a memory unit allocated in heap memory 106. Learning module 112 may learn a most possible memory access order for each function in application 104. Learning module 112 may provide a report of suggestion for a heap memory allocation to heap memory 106 for functions in application 104. Learning module 112 may control whether to trigger a learning mode. For example, a runtime option may specify a function name which needs to optimize. If there is no need of the learning mode, the runtime option may set the learning mode off. Learning module 112 may identify a heap element identity per the allocation request. Learning module 112 may check the learning mode runtime option and check whether the identity of the allocated heap element is prefix with a function name in a monitoring function table. Learning module 112 may mark a memory page in heap memory that operating system should issue a signal when the marked page is accessed. Learning module 112 may check whether the accessed address is in the range of one element in the monitoring element table. Learning module 112 may save a record if the accessed address is in the monitoring element table. Learning module 112 may update a heap free routine. Learning module 112 may check the learning mode runtime option. Learning module 112 may check whether the target heap element is in the monitoring element table. If the target heap element is in the monitoring element table, learning module 112 may remove the record.

In one or more embodiments, optimization module 114 is configured to allocate memory units (e.g., heap elements) which are more likely to access with the order in the same memory page in heap memory 106. When one of the heap elements are allocated, optimization module 114 may set the memory units to occupy the whole page. Optimization module 114 may control whether to trigger an optimization mode. Optimization module 114 may set a runtime option to specify the optimization mode on. Optimization module 114 may set a runtime option to specify the optimization mode off. Optimization module 114 may update a heap allocation routine. Optimization module 114 may check the optimization mode runtime option. Optimization module 114 may determine whether a target heap element needs to be optimized. If optimization module 114 determines that the target heap element needs to be optimized, optimization module 114 determines whether other elements in the same memory page in heap memory 106 has been allocated. If optimization module 114 determines that other elements in the same memory page in heap memory 106 has not been allocated, optimization module 114 reserves the whole memory page to include the heap element. Otherwise, optimization module 114 may return the heap element from the reserved page directly.

In one or more embodiments, monitoring module 116 is configured to monitor data element accessing information associated with the data area triggered by the notification. Monitoring module 116 may generate a monitoring function table that includes functions from application 104. Monitoring module 116 may generate a monitoring element table during runtime to record the data element accessing information. Monitoring module 116 may check whether an accessed address in heap memory 106 for application 104 is in the range of an element in the monitoring element table. Monitoring module 116 may save a record if the accessed address is in the monitoring element table. Monitoring module 116 may generate a report for each function including a distance between data areas accessed in succession and the data areas clustering result. Monitoring module 116 may generate the report of each function for data areas distance and clustering result. In an example, the distance between data areas, e.g., heap element A and heap element B, can reflect the relationship of the heap elements. Monitoring module 116 may define the distance of the heap elements. Monitoring module 116 may calculate average heap elements distance. Monitoring module 116 may discard a disturbance distance by using a pre-defined threshold to control which distance should be involved during the calculation. Monitoring module 116 may calculate only the heap element pairs which has enough significative distances. Monitoring module 116 may cluster heap elements. Each cluster may contain heap elements which total size is no more than one page of memory in heap memory 106.

In one or more embodiments, memory allocation module 118 is configured to allocate heap memory 106 and identify a memory unit per an access request from application 104. Memory allocation module 118 may locate a return address to the caller and may calculate the offset. Memory allocation module 118 may use the offset as an independent identity for the heap element in heap memory 106. In example, the independent identity may include a function name and the offset for this heap element. Memory allocation module 118 determines which elements are allocated on a same memory page in heap memory 106. Memory allocation module 118 may formulate a coarse-grained memory allocation strategy based on memory accessing features to improve caching hit rate. Memory allocation module 118 may use clustering algorithms to analyze memory accessing data and aggregation memory elements whose accessing times are closed into one cluster. Memory allocation module 118 may allocate memory elements in one cluster on the same memory page. Memory allocation module 118 may make the coarse-grained memory allocation strategy as the initial status of a fine-grained strategy. Memory allocation module 118 may use a heuristic algorithm to optimize the coarse-grained strategy. Memory allocation module 118 may use a choice system operation time as the optimization goal to ensure total efficiency. Memory allocation module 118 may orient a real operating efficiency.

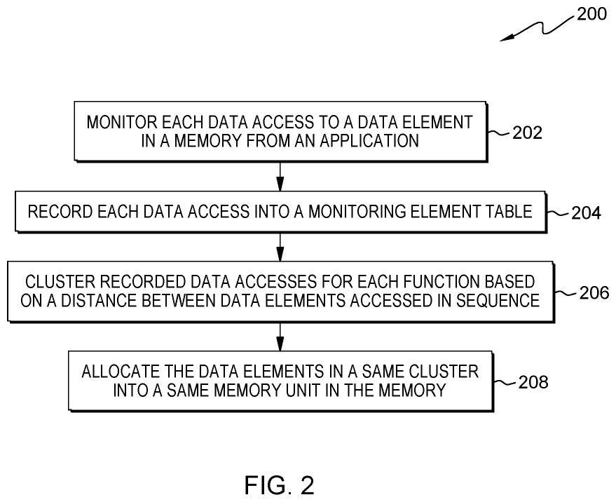

FIG. 2 is a flowchart 200 depicting operational steps of performance improvement module 110 in accordance with an embodiment of the present disclosure.

Performance improvement module 110 operates to monitor each data access to a data element in heap memory 106 from application 104, which may include a plurality of functions. Performance improvement module 110 also operates to record, during runtime, each data access into a monitoring element table. Performance improvement module 110 operates to cluster recorded data accesses for each function based on a distance between data elements accessed in sequence in heap memory 104. Performance improvement module 110 operates to allocate, based on the data element clustering result, the data elements in a same cluster into a same memory unit in heap memory 106.

In step 202, performance improvement module 110 monitors each data access to a data element in heap memory 106 from application 104 which may include a plurality of functions. Performance improvement module 110 may receive a notification, e.g., from operating system 120, that a memory unit (e.g., a data area) in heap memory 106 is accessed. Performance improvement module 110 may receive a signal from signal management 124 when the corresponding data area is accessed. The signal may be used to notify a process of the event that the corresponding data area is accessed. When a signal is sent, operating system 120 may interrupt the target process' normal flow of execution to deliver the signal. Performance improvement module 110 may identify the memory unit when the memory unit is accessed. Performance improvement module 110 may locate a return address to the caller and may calculate the offset. Performance improvement module 110 may use the offset as an independent identity for the heap element (e.g., the memory unit). The identity for the memory unit may include a function name and the offset. For example, if the function name is Func_A ( ), the identity of one heap element (e.g., memory unit) can be Func_A_0000AA.

In step 204, performance improvement module 110 records, during runtime, each data access into a monitoring element table. The record for each data access may include an identity, a start address, an end address, and a memory page number. Performance improvement module 110 may monitor data element accessing information associated with the data area triggered by the notification from signal management 124. Performance improvement module 110 may generate a monitoring function table that includes functions from application 104. Performance improvement module 110 may generate a monitoring element table during runtime to record the data element accessing information. FIGS. 4A-4B illustrate examples of a monitoring function table and a monitoring element table. Performance improvement module 110 may check whether an accessed address in heap memory 106 for application 104 is in the range of an element in the monitoring element table. Performance improvement module 110 may save a record if the accessed address is in the monitoring element table.

In step 206, performance improvement module 110 clusters recorded data accesses for each function based on a distance between data elements accessed in sequence in heap memory 104. Performance improvement module 110 may generate a report for each function including a distance between data areas accessed in succession and a data area clustering result. Performance improvement module 110 may generate the report of each function for the data area distance and the clustering result. In an example, the distance between data areas, e.g., heap element A and heap element B, can reflect the relationship of the heap elements. Performance improvement module 110 may define the distance of the heap elements. Performance improvement module 110 may calculate average heap elements distance. Performance improvement module 110 may discard a disturbance distance by using a pre-defined threshold to control which distance should be involved during the calculation. Performance improvement module 110 may calculate only the heap element pairs which has enough significative distances. Performance improvement module 110 may cluster heap elements. Each cluster may contain heap elements which total size is no more than one page of memory in heap memory 106.

In step 208, performance improvement module 110 allocates, based on the data element clustering result, the data elements in a same cluster into a same memory unit in heap memory 106. Performance improvement module 110 may allocate the data areas in one cluster in a same memory management unit to improve the data access performance. Performance improvement module 110 may allocate data areas in a memory unit based on the generated report. Performance improvement module 110 may determine which heap elements should be allocated on the same memory page in heap memory 106. Performance improvement module 110 may generate a coarse-grained memory allocation strategy. For example, performance improvement module 110 may formulate the coarse-grained memory allocation strategy based on memory accessing features to improve a caching hit rate. Performance improvement module 110 may use a clustering algorithm to analyze memory accessing data and aggregation memory elements whose accessing times may be close in one cluster. Performance improvement module 110 may allocate heap memory elements in one cluster on a same memory page in heap memory 106. Performance improvement module 110 may generate a fine-grained memory allocation strategy. Performance improvement module 110 may make the coarse-grained memory allocation strategy as the initial status of the fine-grained memory allocation strategy. For example, performance improvement module 110 may use a heuristic algorithm to optimize the coarse-grained memory allocation strategy. Performance improvement module 110 may choose a system operation time as the optimization goal to ensure total efficiency based on the strategy.

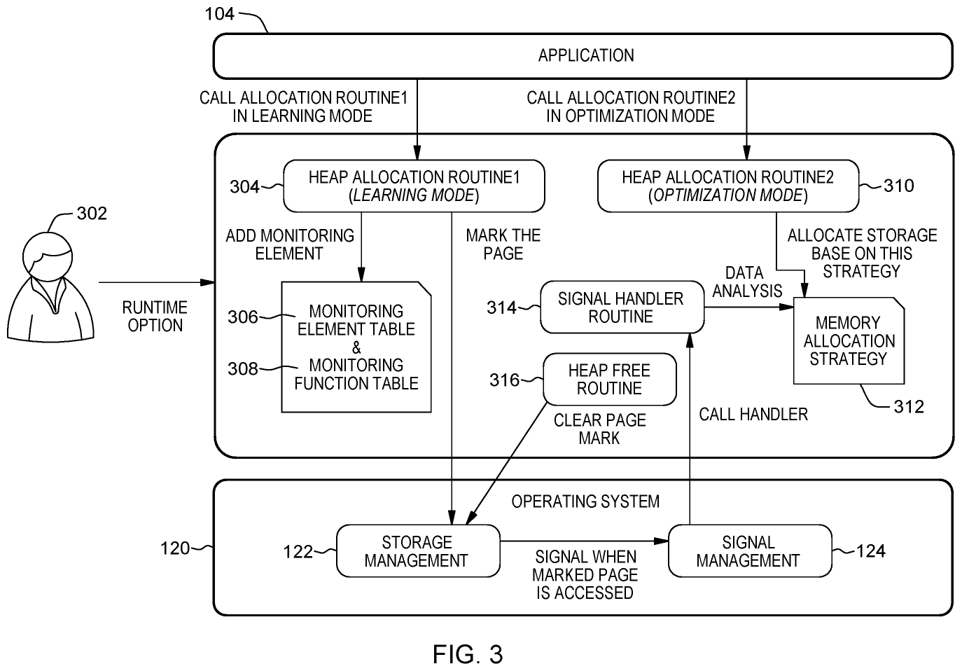

FIG. 3 illustrates an exemplary functional diagram of performance improvement module 110 in computing device 102 in accordance with one or more embodiments of the present disclosure.

In the example of FIG. 3, application 104 may call a heap allocation routine in learning mode 304. The heap allocation routine may add a monitoring element into monitoring element table 306 and monitoring function table 308. The heap allocation routine may mark a memory page in heap memory 106 in storage management 122. Operating system 120 may send a signal through signal management 124 when a marked page is accessed by application 104. Signal handler routine 314 may perform data analysis and generate memory allocation strategy 312. Performance improvement module 110 may allocate storage based on memory allocation strategy 312. In another example, application 104 may call an allocation routine in optimization mode 310. User 302 may perform runtime option in learning mode 304 and optimization mode 310.

FIG. 4A illustrates an exemplary monitoring function table of performance improvement module 110 in computing device 102 in accordance with one or more embodiments of the present disclosure. FIG. 4B illustrates an exemplary monitoring element table of performance improvement module 110 in computing device 102 in accordance with one or more embodiments of the present disclosure.

In the example of FIG. 4A, performance improvement module 110 may generate monitoring function table 306 that includes functions 402 from application 104. Monitoring function table 306 may save functions 402 to be optimized. Performance improvement module 110 may check the learning mode runtime option and may determine whether the identity of the allocated heap element is prefixed with a function name in monitoring function table 306. In the example of FIG. 4B, performance improvement module 110 may generate monitoring element table 308 during runtime to record the data element accessing information. Monitoring element table 308 may save heap elements 412 to be monitored. Each heap element 412 includes identity 404, start address 406, end address 408, and page 410. Performance improvement module 110 may determine whether the accessed address is in the range of one element in monitoring element table 308. Performance improvement module 110 may store a record if the accessed address is in monitoring element table 308. Performance improvement module 110 may find return address to the caller and calculate the offset. The offset can be used as the independent identity for heap element 412. Identity 404 may include the function name and the independent identity for heap element 412. For example, if the function name is Func_A( ), the identity of one heap element can be Func_A_0000AA.

FIG. 5 depicts a block diagram 500 of components of computing device 102 in accordance with an illustrative embodiment of the present disclosure. It should be appreciated that FIG. 5 provides only an illustration of one implementation and does not imply any limitations with regard to the environments in which different embodiments may be implemented. Many modifications to the depicted environment may be made.

Computing device 102 may include communications fabric 502, which provides communications between cache 516, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses or a crossbar switch.

Memory 506 and persistent storage 508 are computer readable storage media. In this embodiment, memory 506 includes random access memory (RAM). In general, memory 506 can include any suitable volatile or non-volatile computer readable storage media. Cache 516 is a fast memory that enhances the performance of computer processor(s) 504 by holding recently accessed data, and data near accessed data, from memory 506.

Performance improvement module 110 may be stored in persistent storage 508 and in memory 506 for execution by one or more of the respective computer processors 504 via cache 516. In an embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 510, in these examples, provides for communications with other data processing systems or devices. In these examples, communications unit 510 includes one or more network interface cards. Communications unit 510 may provide communications through the use of either or both physical and wireless communications links. Performance improvement module 110 may be downloaded to persistent storage 508 through communications unit 510.

I/O interface(s) 512 allows for input and output of data with other devices that may be connected to computing device 102. For example, I/O interface 512 may provide a connection to external devices 518 such as a keyboard, keypad, a touch screen, and/or some other suitable input device. External devices 518 can also include portable computer readable storage media such as, for example, thumb drives, portable optical or magnetic disks, and memory cards. Software and data used to practice embodiments of the present invention, e.g., performance improvement module 110 can be stored on such portable computer readable storage media and can be loaded onto persistent storage 508 via I/O interface(s) 512. I/O interface(s) 512 also connect to display 520.

Display 520 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Python, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
monitoring, by one or more processors, each data access to a data element in memory from an application, wherein the application has a plurality of functions;
recording, by one or more processors, during runtime, each data access into a monitoring element table, wherein the record for each data access includes an identity, a start address, an end address, and a memory page number;
clustering, by one or more processors, recorded data accesses for each function based on a distance between data elements accessed in sequence; and
allocating, by one or more processors, based on the data element clustering result, the data elements in a same cluster into a same memory unit in the memory.

2. The computer-implemented method of claim 1, further comprising:
receiving, by one or more processors, a notification that the data element in the memory is accessed by the application.

3. The computer-implemented method of claim 2, wherein the notification is a signal generated from an operating system when an event to access the memory has occurred.

4. The computer-implemented method of claim 1, wherein clustering the recorded data accesses comprises analyzing memory accessing data and aggregation memory elements.

5. The computer-implemented method of claim 1, further comprising:
enabling a learning mode in runtime; and
determining which function is to be optimized to access data in the memory.

6. The computer-implemented method of claim 1, wherein the memory is a heap memory used by a programming language to store global variables for the application.

7. The computer-implemented method of claim 1, wherein the monitoring element table is associated with a monitoring function table including the plurality of functions from the application.

8. A computer program product comprising:
one or more computer readable storage media, and program instructions collectively stored on the one or more computer readable storage media, the program instructions comprising:
program instructions to monitor each data access to a data element in memory from an application, wherein the application has a plurality of functions;
program instructions to record, during runtime, each data access into a monitoring element table, wherein the record for each data access includes an identity, a start address, an end address, and a memory page number;
program instructions to cluster, recorded data accesses for each function based on a distance between data elements accessed in sequence; and
program instructions to allocate, based on the data element clustering result, the data elements in a same cluster into a same memory unit in the memory.

9. The computer program product of claim 8, further comprising:
program instructions, stored on the one or more computer-readable storage media, to receive a notification that the data element in the memory is accessed by the application.

10. The computer program product of claim 9, wherein the notification is a signal generated from an operating system when an event to access the memory has occurred.

11. The computer program product of claim 8, wherein program instructions to cluster the recorded data accesses comprise program instructions to analyze memory accessing data and aggregation memory elements.

12. The computer program product of claim 8, further comprising:
program instructions to enable a learning mode in runtime; and
program instructions to determine which function is to be optimized to access data in the memory.

13. The computer program product of claim 8, wherein the memory is a heap memory used by a programming language to store global variables for the application.

14. The computer program product of claim 8, wherein the monitoring element table is associated with a monitoring function table including the plurality of functions from the application.

15. A computer system comprising:
one or more computer processors, one or more computer readable storage media, and program instructions stored on the one or more computer readable storage media for execution by at least one of the one or more computer processors, the program instructions comprising:
program instructions to monitor each data access to a data element in memory from an application, wherein the application has a plurality of functions;
program instructions to record, during runtime, each data access into a monitoring element table, wherein the record for each data access includes an identity, a start address, an end address, and a memory page number;
program instructions to cluster, recorded data accesses for each function based on a distance between data elements accessed in sequence; and
program instructions to allocate, based on the data element clustering result, the data elements in a same cluster into a same memory unit in the memory.

16. The computer system of claim 15, further comprising:
program instructions, stored on the one or more computer-readable storage media, to receive a notification that the data element in the memory is accessed by the application.

17. The computer system of claim 16, wherein the notification is a signal generated from an operating system when an event to access the memory has occurred.

18. The computer system of claim 15, wherein program instructions to cluster the recorded data accesses comprise program instructions to analyze memory accessing data and aggregation memory elements.

19. The computer system of claim 15, further comprising:
program instructions to enable a learning mode in runtime; and
program instructions to determine which function is to be optimized to access data in the memory.

20. The computer system of claim 15, wherein the memory is a heap memory used by a programming language to store global variables for the application.
